(19) United States
(12) Patent Application Publication
(10) Pub. No.: US 2013/0300730 A1
(43) Pub. Date: Nov. 14, 2013

(54) LCD SYSTEM AND METHOD FOR DISPLAYING IMAGE THEREIN

(71) Applicant: Hsiao Hsien Chen, Shenzhen (CN)

(72) Inventor: Hsiao Hsien Chen, Shenzhen (CN)

(73) Assignee: SHENZHEN CHINA STAR OPTOELECTRONICS TECHNOLOGY CO., LTD., Guangdong (CN)

(21) Appl. No.: 13/574,523

(22) PCT Filed: May 25, 2012
(86) PCT No.: PCT/CN12/76063

§ 371 Date: Jul. 20, 2012

(30) Foreign Application Priority Data
May 14, 2012 (CN) 201210147673.0

(51) Int. Cl. G06T 15/00; G09G 3/36

(52) U.S. Cl. 345/419; 345/87

(57) ABSTRACT

The present invention discloses a liquid crystal display (LCD) system, which includes an LCD device. The LCD device includes: a display mode setting module utilized to set display modes of the LCD device. The display mode includes at least a multi-3D-image display mode, the display mode setting module electrically coupled to the control module. The control module is utilized to control the scan driving module and the data driving module according to the display modes.

### FIELD OF THE INVENTION

The present invention relates to a liquid crystal display (LCD) technology, and especially to an LCD system and a method for displaying images therein.

### BACKGROUND OF THE INVENTION

Conventional three-dimensional (3D) displays include a color-division 3D display, a light-division 3D display, and a time-division 3D display. Those 3D displays provide stereoscopic vision with an immersed sense for a user, and enrich the user's life.

At present, more and more images can be reproduced as 3D images, so the 3D images offered to the user also grow more and more. However, different users have various preferences, but the conventional 3D displays can only output an image of a program at the same time. That is, those users who simultaneously view the 3D display can only view the single image of the program. When the users have the various preferences for viewing, the conventional 3D display can not satisfy demands of all the users.

Therefore, there is a need to provide a new 3D display for satisfying the demands that multiple users view different images at the same time.

### SUMMARY OF THE INVENTION

An objective of the present invention is to provide an LCD system, which is capable of outputting one or more images to multiple users at the same time, for satisfying the demands that the multiple users view different images at the same time.

To achieve the foregoing objective, an LCD system provided by the present invention includes: an LCD device, the LCD device comprising: a LCD panel; a data driving module; a scan driving module; a control module. The control module is electrically coupled to the data driving module and the scan driving module, and both the data driving module and the scan driving module are electrically coupled to the LCD panel. The LCD device further includes: a display mode setting module, utilized to set display modes of the LCD device, the display mode comprising at least a multi-3D-image display mode, the display mode setting module electrically coupled to the control module, the control module utilized to control the scan driving module and the data driving module according to the display modes; a data processing module, the control module electrically coupled to the data processing module, the data processing module electrically coupled to the data driving module, the control module further utilized to control the data processing module according to the display modes, the data processing module utilized to obtain one or more sets of image data according to a controlling signal of the control module and to process the one or more sets of the image data, and utilized to provide the processed image data for the data driving module. The scan driving module is further utilized to increase or decrease an output frequency of a scan signal according to the controlling signal of the control module. The data driving module is further utilized to increase or decrease an output frequency of a data signal according to the controlling signal of the control module.

In the above-mentioned LCD system, the LCD system further includes glasses utilized to view images displayed by the LCD device, and the glasses is further utilized to be passed by the images displayed by the LCD device according to the display mode set by the display mode setting module.

In the above-mentioned LCD system, in the multi-3D-image display mode, the LCD panel outputs a left-eye image/a right-eye image of one or more sets of images in sequence, and then outputs a right-eye image/a left-eye image of the one or more sets of images in sequence.

In the above-mentioned LCD system, in the multi-3D-image display mode, the LCD panel is utilized to output a left-eye image and a right-eye image of a first set of images on a first polarized direction in sequence, and to simultaneously output a left-eye image and a right-eye image of a second set of images on a second polarized direction differed from the first polarized direction in sequence.

In the above-mentioned LCD system, in the multi-3D-image display mode, the LCD panel is utilized to firstly output a left-eye image and a right-eye image of a first set of images simultaneously on a first polarized direction and a second polarized direction differed from the first polarized direction, and then simultaneously outputs a left-eye image and a right-eye image of a second set of images on the first polarized direction and the second polarized direction.

Another objective of the present invention is to provide an LCD system, which is capable of outputting one or more images to multiple users at the same time, for satisfying the demands that the multiple users view different images at the same time.

To achieve the foregoing objective, an LCD system provided by the present invention includes an LCD device. The LCD device includes an LCD panel, a data driving module, a scan driving module, and a control module. The control module is electrically coupled to the data driving module and the scan driving module, and both the data driving module and the scan driving module are electrically coupled to the LCD panel. The LCD device further includes: a display mode setting module, utilized to set display modes of the LCD device, the display mode comprising at least a multi-3D-image display mode, the display mode setting module electrically coupled to the control module. The control module is utilized to control the scan driving module and the data driving module according to the display modes.

In the above-mentioned LCD system, the LCD device further comprises a data processing module, the control module electrically coupled to the data processing module, the data processing module electrically coupled to the data driving module. The control module is further utilized to control the data processing module according to the display modes. The data processing module is utilized to obtain one or more sets of image data according to a controlling signal of the control module and to process the one or more sets of the image data, and utilized to provide the processed image data for the data driving module.

In the above-mentioned LCD system, the scan driving module further utilized to increase or decrease an output frequency of a scan signal according to the controlling signal of the control module; and/or the data driving module is further utilized to increase or decrease an output frequency of a data signal according to the controlling signal of the control module.

In the above-mentioned LCD system, the LCD system further comprises glasses utilized to view images displayed by the LCD device, the glasses further utilized to be passed by the images displayed by the LCD device according to the display mode set by the display mode setting module.

In the above-mentioned LCD system, in the multi-3D-image display mode, the LCD panel firstly outputs a left-eye image/a right-eye image of one or more sets of images in sequence, and then outputs a right-eye image/a left-eye image of the one or more sets of images in sequence; or the LCD panel outputs a left-eye image and a right-eye image of a first set of images on a first polarized direction in sequence, and simultaneously outputs a left-eye image and a right-eye image of a second set of images on a second polarized direction differed from the first polarized direction in sequence; or the LCD panel firstly outputs a left-eye image and a right-eye image of the first set of images simultaneously on a first polarized direction and a second polarized direction differed from the first polarized direction, and then simultaneously outputs a left-eye image and a right-eye image of a second set of images on the first polarized direction and the second polarized direction.

Yet another objective of the present invention is to provide a method for displaying images in an LCD system, which is capable of outputting one or more images to multiple users at the same time, for satisfying the demands that the multiple users view different images at the same time.

To achieve the foregoing objective, the present invention provides a method for displaying images in an LCD system. The LCD system includes an LCD device, which comprises an LCD panel, a data driving module, a scan driving module, and a control module. The control module is electrically coupled to the data driving module and the scan driving module, and both the data driving module and the scan driving module are electrically coupled to the LCD panel. The LCD device further comprises a display mode setting module, and the display mode setting module is electrically coupled to the control module. The method includes the following steps of: (A) setting display modes of the LCD device by the display mode setting module, the display mode comprising at least a multi-3D-image display mode; (B) controlling the scan driving module and the data driving module by the control module according to the display modes.

In the above-mentioned method for displaying images in the LCD system, the LCD device further comprises a data processing module, the control module is electrically coupled to the data processing module, and the control module is further utilized to control the data processing module according to the display modes. The method further includes the following step of: (C) obtaining one or more sets of image data by the data processing module according to a controlling signal of the control module and to process the one or more sets of the image data, and providing the processed image data for the data driving module.

In the above-mentioned method for displaying images in the LCD system, the method further comprising the following step of: (D) increasing or decreasing an output frequency of a scan signal by the scan driving module according to the controlling signal of the control module; and/or (E) increasing or decreasing an output frequency of a data signal by the data driving module according to the controlling signal of the control module.

In the above-mentioned method for displaying images in the LCD system, the LCD system further includes glasses utilized to view images displayed by the LCD device. The method further includes the following step of: (F) passing through the glasses by the images displayed by the LCD device according to the display mode set by the display mode setting module.

In the above-mentioned method for displaying images in the LCD system, in the multi-3D-image display mode, the method further includes the following step of: (G) firstly outputting a left-eye image/a right-eye image of one or more sets of images in sequence, and then outputting a right-eye image/a left-eye image of the one or more sets of images in sequence by the LCD panel; or (H) outputting a left-eye image and a right-eye image of a first set of images on a first polarized direction in sequence by the LCD panel, and simultaneously outputs a left-eye image and a right-eye image of a second set of images on a second polarized direction differed from the first polarized direction in sequence; or (I) firstly outputting a left-eye image and a right-eye image of a first set of images simultaneously on a first polarized direction and a second polarized direction differed from the first polarized direction by the LCD panel, and then simultaneously outputs a left-eye image and a right-eye image of the second set of images on the first polarized direction and the second polarized direction.

In comparison with the prior art, the plurality of display modes can be set in the present invention, the multiple images can be displayed on LCD panel by controlling the data signals and the scan signals of the multiple images according to the different display mode being set. The present invention can provide the multiple images for the multiple users. The images can be 2D images, and can also be 3D images, thereby enriching viewing experiences of the users and satisfying the demands that the users view different images at the same time. Because the various display modes can be set for controlling the multiple images, such as controlling the data signals and the scan signals, the multiple images simultaneously provided for the users won't disturb each other in the present invention.

It is to be understood that both the foregoing general description and the following detailed description of the present invention are exemplary and explanatory and are intended to provide further explanation of the invention as claimed.

### DESCRIPTION OF THE DRAWINGS

FIG. 1 is a block diagram illustrating an LCD device according to an LCD system of the present invention;

FIG. 2 is a schematic drawing illustrating a first display mode according to the present invention;

FIG. 3 is a schematic drawing illustrating a second display mode according to the present invention;

FIG. 4 is a schematic drawing illustrating a third display mode according to the present invention;

FIG. 5 is a schematic drawing illustrating a fourth display mode according to the present invention;

FIG. 6 is a schematic drawing illustrating a fifth display mode according to the present invention; and

FIG. 7 is a flow chart illustrating a method for displaying images in the LCD system of the present invention.

### DETAILED DESCRIPTION OF THE PREFERRED EMBODIMENTS

Descriptions of the following embodiments refer to attached drawings which are utilized to exemplify specific embodiments.

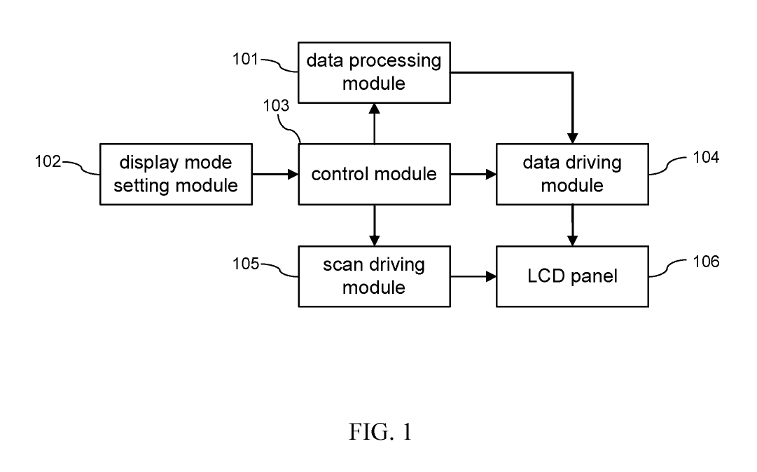

Referring to FIG. 1, FIG. 1 is a block diagram illustrating an LCD device according to an LCD system of the present invention. The LCD device of the present invention includes an LCD panel 106, a data driving module 104, a scan driving module 105, a control module 103, a display mode setting module 102, and a data processing module 101. The data driving module 104 and the scan driving module 105 are electrically coupled to the LCD panel 106. The control module 103 is electrically coupled to the data processing module 101, the data driving module 104, and the scan driving module 105. The display mode setting module 102 is electrically coupled to the control module 103, and the data processing module 101 is electrically coupled to the data driving module 104. The display mode setting module 102 is utilized to set display modes. The display modes include a single-3D-image display mode, a multi-3D-image display mode, a single-2D-image display mode, a multi-2D-image display mode, and so on. The images herein include TV programs, movies, videos, and so on. The single image herein is designated as a set of image, and the multi image herein is designated as two or more sets of images. The control module 103 is utilized to control the data driving module 104 and the scan driving module 105 according to the display mode being set by the display mode setting module 102. Specifically, the control module 103 increases or decreases a frequency of a scan signal output by the scan driving module 105, and/or increases or decreases a frequency of a data signals output by the data driving module 104. The data processing module 10 utilized to obtain one or more sets of image data according to the display mode set by the display mode setting module 102 and to process the one or more sets of the image data, and utilized to dispatch the processed image data for the data driving module 104.

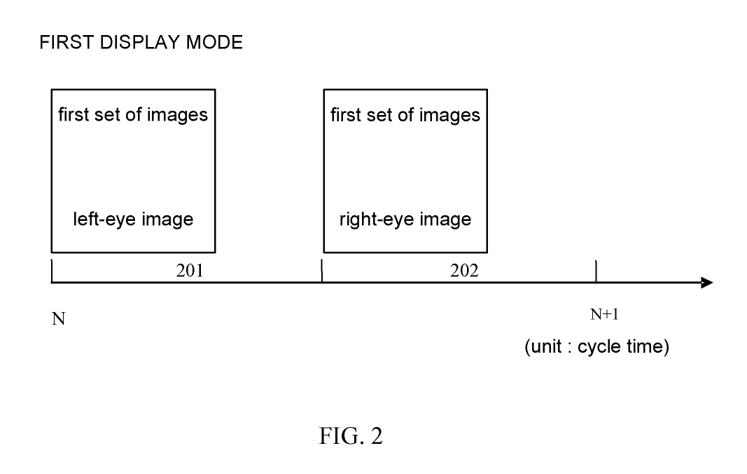

Referring to FIG. 2, FIG. 2 is a schematic drawing illustrating a first display mode according to the present invention. The first display mode is the single-3D-image display mode. In the schematic drawing, the LCD system of the present invention displays a 3D image of a set of images (represented as a first set of images), in which the images includes TV programs, movies, videos, and so on. The LCD system displays a left-eye image in the first set of images at a beginning of a cycle time, and then displays a right-eye image in the first set of images. The cycle time is designated as a time interval from beginning to displaying a frame till beginning to display the next frame. After the display mode setting module 102 sets the display mode as the first display mode, The control module 103 controls the data processing module 101 according to the display mode, and then the data driving module 104 and the scan driving module 105 perform corresponding operations according to the first display mode. The data processing module 101 obtains a first set of image data then to respectively process left-eye image data and right-eye image data in the first set of image data, and then dispatch the processed left and right eye image data to the data driving module 104. The data driving module 104 outputs the left and right eye image data of the first set of image data to the LCD panel 106 respectively at time interval 201 and time interval 202. The scan driving module 105 outputs scan signals to the LCD panel 106 respectively at the time interval 201 and the time interval 202. A left lens of shutter glasses is on an open state at the time interval 201, and a right lens thereof is on a close state. At the time interval 202, the left lens is on the close state, and the right lens is on the open state. Therefore, during the single cycle time, a user can view the 3D image of a single frame.

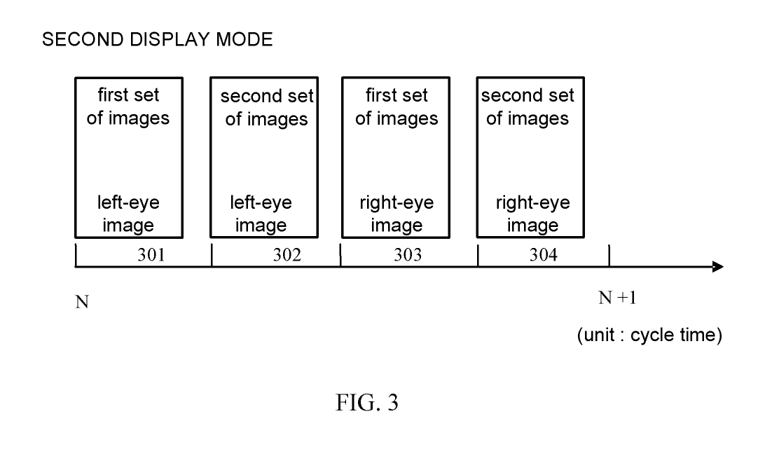

Referring to FIG. 3, FIG. 3 is a schematic drawing illustrating a second display mode according to the present invention. The second display mode is the multi-3D-image display mode. The images herein include TV programs, movies, videos, and so on. The multi image herein is designated as two or more sets of images. FIG. 3 illustrates two images (represented as a first set of images and a second set of images respectively). Certainly, the LCD system of the present invention is also capable of displaying more than two sets of images based on the concept of the present invention. In the drawing, the LCD system respectively displays a left-eye image in the first set of images, a left-eye image in the second set of images, a right-eye image in the first set of images, and a right-eye image in the second set of images in the single cycle time in sequence. The display mode setting module 102 sets the display mode as the second display mode. The control module 103 controls the data processing module 101, and the data driving module 104 and the scan driving module 105 perform corresponding operations according to the second display mode. The data processing module 101 obtains two sets of image data, which are a first set of image data and a second set of image data respectively. Then the data processing module 101 respectively processes the left and right eye image data in the first set of image data as well as the left and right eye image data in the second set of image data, and then dispatches the processed image data to the data driving module 104. The data driving module 104 outputs the left-eye image data of the left-eye image data to the LCD panel 106 at time interval 301, and outputs the left-eye image data of the second set of image data at time interval 302, and outputs the right-eye image data of the first set of image data at time interval 303, and outputs the right-eye image data of the second set of image data at time interval 304. The scan driving module 105 outputs the scan signals to the LCD panel 106 respectively at the time interval 301, the time interval 302, the time interval 303, and the time interval 304, so that LCD panel 106 displays the left-eye image in the first set of images, the left-eye image in the second set of images, the right-eye image in the first set of images, and the right-eye image in the second set of images respectively at the time interval 301, the time interval 302, the time interval 303, and the time interval 304. At the time interval 301, the left lens of shutter glasses A is on the open state, and the right lens thereof is on the close state. At the time interval 303, the left lens is on the close state, and the right lens is on the open state. At the time interval 302 and the time interval 304, both the left and right lenses are on the close state. At the time interval 302, the left lens of shutter glasses B is on the open state, and the right lens thereof is on the close state. At the time interval 304, the left lens is on the close state, and the right lens is on the open state. At the time interval 301 and the time interval 303, both the left and right lenses are on the close state. That is, in the multi-3D-image display mode, the LCD panel outputs one or more sets of the left-eye image/the right-eye image in sequence, and then outputs one or more sets of the right-eye image/the left-eye image in sequence. Therefore, during the single cycle time, two or more users can respectively view the 3D images of two frames.

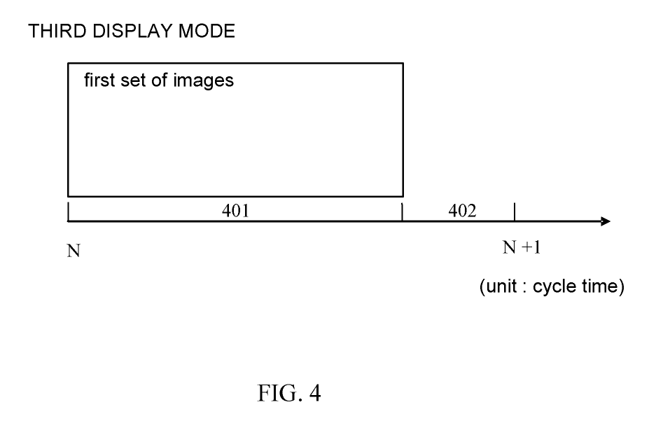

Referring to FIG. 4, FIG. 4 is a schematic drawing illustrating a third display mode according to the present invention. The third display mode is the single-2D-image display mode. The images herein include TV programs, movies, videos, and so on. The single image herein is designated as one set of images. In the drawing, the LCD system of the present invention displays a 2D image of a set of images (a first set of images). The LCD system displays the first set of images at the beginning of the cycle time; meanwhile, the user can view the images by his naked eyes. The display mode setting module 102 sets the display mode as the third display mode. The control module 103 controls the data processing module 101, and the data driving module 104 and the scan driving module 105 perform corresponding operations according to the third display mode. The data processing module 101 obtains a first set of image data then to process the first set of image data, and dispatches the processed first set of image data to the data driving module 104. The data driving module 104 outputs the first set of image data to the LCD panel 106 at a time interval 401. The scan driving module 105 outputs the scan signals to the LCD panel 106 respectively at the time intervals 401 and 402, so that the LCD panel 106 displays the first set of images at the time intervals 401 and stops displaying the first set of images at the time intervals 402, or so that the LCD panel 106 displays the first set of images at the time intervals 401 and 402. If the user wants to view the images by the shutter glasses, the left and right lenses of the shutter glasses should be set to close and open simultaneously. At the time interval 401, both the left and right lenses of the shutter glasses are on the open state. At the time interval 402, both the left and right lenses of the shutter glasses are on the close state. Or both the left and right lenses of the shutter glasses are on the open state at the time interval 401 and the time interval 402.

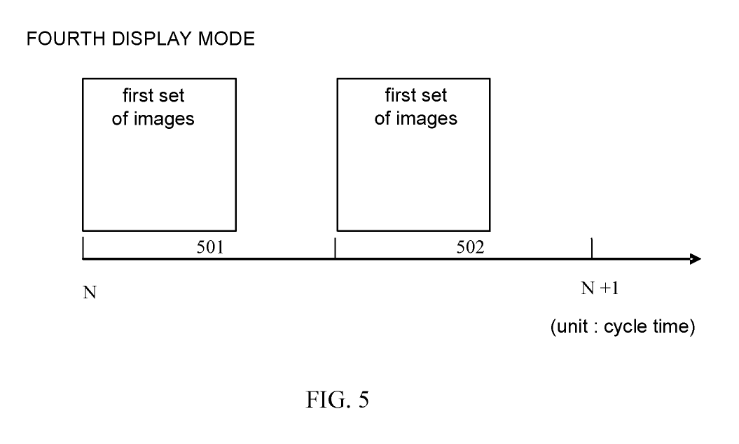

Referring to FIG. 5, FIG. 5 is a schematic drawing illustrating a fourth display mode according to the present invention. The fourth display mode is the single-2D-image display mode. The images herein include TV programs, movies, videos, and so on. The single image herein is designated as one set of images. In the drawing, the LCD system of the present invention displays a 2D image of a set of images (first set of images). The LCD system successively outputs the first set of images twice in the single cycle time. The display mode setting module 102 sets the display mode as the fourth display mode. The control module 103 controls the data processing module 101, and the data driving module 104 and the scan driving module 105 perform corresponding operations according to the fourth display mode. The data processing module 101 obtains a first set of image data then to process the first set of image data, and dispatches the processed first set of image data to the data driving module 104. The data driving module 104 outputs the first set of image data twice to the LCD panel 106 respectively at a time interval 501 and a time interval 502. The scan driving module 105 outputs the scan signals to the LCD panel 106 respectively at the time intervals 501 and 502, so that the LCD panel 106 displays the first set of images twice respectively at the time intervals 501 and 502. At the time interval 501, the left lens of shutter glasses is on the open state, and the right lens thereof is on the close state. At the time interval 502, the left lens of shutter glasses is on the close state, and the right lens thereof is on the open state. Meanwhile, the user can view the images by the shutter glasses.

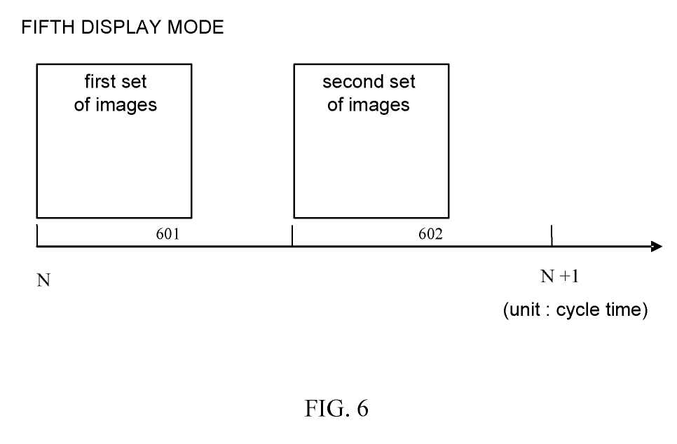

Referring to FIG. 6, FIG. 6 is a schematic drawing illustrating a fifth display mode according to the present invention. The fifth display mode is the multi-2D-image display mode. The images herein include TV programs, movies, videos, and so on. The multi image herein is designated as two or more sets of images. In the drawing, the LCD system of the present invention displays 2D images of two sets of images (represented as a first set of images and a second set of images respectively). The LCD system successively outputs the first set of images and the second set of images in the single cycle time. The display mode setting module 102 sets the display mode as the fifth display mode. The control module 103 controls the data processing module 101 according to the display mode, and then the data driving module 104 and the scan driving module 105 perform corresponding operations. The data processing module 101 obtains two sets of image data, which are a first set of image data and a second set of image data respectively. Then the data processing module 101 respectively processes the first set of image data and the second set of image data, and then dispatches the processed image data to the data driving module 104. The data driving module 104 outputs the first set of image data to the LCD panel 106 at a time interval 601, and outputs the second set of image data to the LCD panel 106 at a time interval 602. The scan driving module 105 outputs the scan signals to the LCD panel 106 respectively at the time intervals 601 and 602, so that the LCD panel 106 displays the first set of images and the second set of images respectively at the time intervals 601 and 602. If the user wants to view the first set of images, the left and right lenses of the shutter glasses A should be set to close and open simultaneously. Similarly, if the user wants to view the second set of images, the left and right lenses of the shutter glasses B should be set simultaneously to close and open, too. However, an open duration of the left and right lenses of the shutter glasses A is within the time interval of a close duration of the left and right lenses of the shutter glasses B, also the open duration of the left and right lenses of the shutter glasses B is within the time interval of the close duration of the left and right lenses of the shutter glasses A. At the time interval 601, both the left and right lenses of the shutter glasses A are on the open state, and both the left and right lenses of the shutter glasses B are on the close state. At the time interval 602, both the left and right lenses of the shutter glasses A are on the close state, and both the left and right lenses of the shutter glasses B are on the open state.

The concept of the present invention has been exemplarily explained by the above-mentioned LCD device which reproduces the 3D images through a time-division manner. Certainly, the concept of the present invention also can be explained by the LCD device which reproduces the 3D images through a light-division manner (polarization type). For example, the display mode setting module 102 sets the display mode, such as the multi-2D-image display mode. The images herein include TV programs, movies, videos, and so on. The multi image herein is designated as two or more sets of images. The control module 103 controls the data processing module 101, the data driving module 104, and the scan driving module 105 according to the display mode. The data processing module 101 obtains two sets of image data, which represented as the first set of image data and the second set of image data respectively. Then the data processing module 101 respectively processes the two sets of image data, and then dispatches the processed image data to the data driving module 104. The data driving module 104 outputs the first set of image data and the second set of image data to the LCD panel 106. The scan driving module 105 outputs the scan signals to the LCD panel 106, so that the LCD panel 106 reproduces the first set of images and the second set of images by the light-division principle. The left and right lenses of polarization glasses C are set to have the same state with regard to polarized directions. For example, the polarized directions of both are a horizontal direction. The left and right lenses of polarization glasses D are set to have the same state with regard to polarized directions. For example, the polarized directions of both are a vertical direction. Accordingly, the polarization glasses C and the polarization glasses D can serve the users simultaneously to view different images, such as the first set of images and the second set of images.

Besides, the display mode setting module 102 sets the display mode as the fifth display mode which is shown in FIG. 6. The control module 103 determines that the data processing module 101 needs to process the two sets of image data and to display the 3D images of the two sets of images according to the display mode. Then the control module 103 controls the data processing module 101, the data driving module 104, and the scan driving module 105 according to the determined result. The data processing module 101 obtains two sets of image data, which represented as the first set of image data and the second set of image data respectively. Then the data processing module 101 respectively processes every set of image data, and then dispatches the processed image data to the data driving module 104. The data driving module 104 outputs the first set of image data and the second set of image data to the LCD panel 106 respectively at the time interval 601 and the time interval 602. The scan driving module 105 outputs scan signals to the LCD panel 106 602 respectively at the time interval 601 and the time interval. Mixed glasses can be acquired from a superimposed combination of a shutter lens of the typical shutter glasses and a polarized lens of the typical polarization glasses. That is, the left lens of the mixed glasses is the superimposed combination of the left lens of the typical shutter glasses and the left lens of the typical polarization glasses, and the right lens of the mixed glasses is the superimposed combination of the right lens of the typical shutter glasses and the right lens of the typical polarization glasses. At the time interval 601, the shutters of both the left and right lenses of a mixed glasses E are simultaneously open, and the shutters of both the left and right lenses of a mixed glasses F are simultaneously close. Meanwhile, the left and right eye images of the first set of images with different polarized directions can pass through the left and right lenses of the mixed glasses E. At the time interval 602, the shutters of both the left and right lenses of a mixed glasses E are simultaneously close, and the shutters of both the left and right lenses of a mixed glasses F are simultaneously open. Meanwhile, the left and right eye images of the second set of images with different polarized directions can pass through the left and right lenses of the mixed glasses F. Accordingly, the mixed glasses E and the mixed glasses F can serve the users simultaneously to view different 3D images. That is, in the multi-3D-image display mode, the LCD panel firstly outputs a left-eye image and a right-eye image of the first set of images simultaneously on a first polarized direction and a second polarized direction differed from the first polarized direction, and then simultaneously outputs a left-eye image and a right-eye image of the second set of images on the first polarized direction and the second polarized direction.

Besides, both the left and right polarized lenses of the mixed glasses E are set to have the same state with regard to the polarized directions, such as the horizontal direction, as well as both the left and right polarized lenses of the mixed glasses F are set to have the same state with regard to the polarized directions, such as the vertical direction. The polarized directions of the mixed glasses E and the mixed glasses F are perpendicular to each other. The left shutter lens of the mixed glasses E and the left shutter lens of the mixed glasses F are simultaneously open and close, and the right shutter lens of the mixed glasses E and the right shutter lens of the mixed glasses F are simultaneously open and close. Accordingly, the mixed glasses E and the mixed glasses F can serve the users simultaneously to view different 3D images. That is, in the multi-3D-image display mode, the LCD panel outputs a left-eye image and a right-eye image of the first set of images on a first polarized direction in sequence, and to simultaneously output a left-eye image and a right-eye image of the second set of images on a second polarized direction differed from the first polarized direction in sequence.

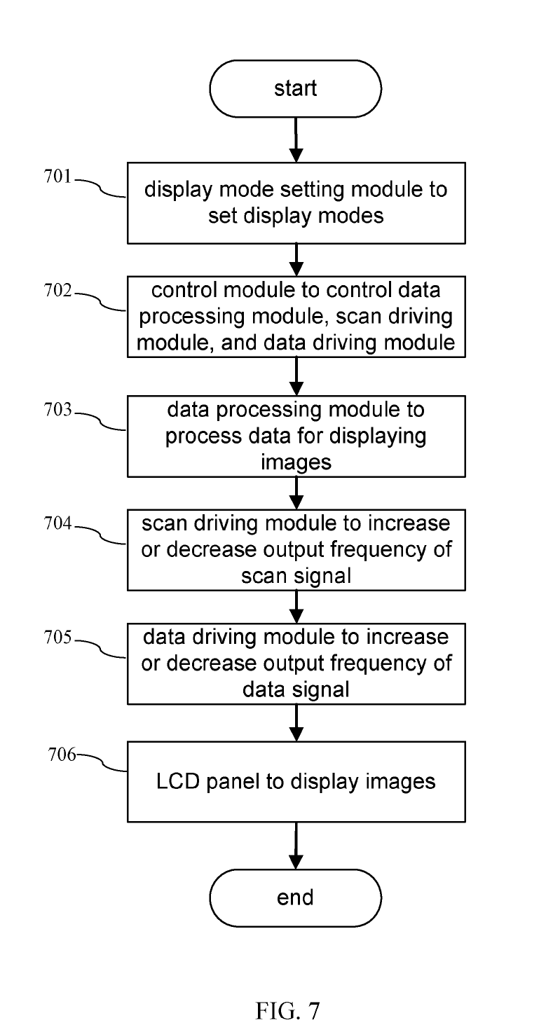

Referring to FIG. 7, FIG. 7 is a flow chart illustrating a method for displaying images in the LCD system of the present invention. At step 701, the display mode setting module 102 sets the display modes. At step 702, the control module 103 determines whether one or more than one set of images is displayed, and determines whether 3D images or 2D images are displayed according to the display mode. Then the control module 103 controls the data processing module 101, the scan driving module 105, and the data driving module 104 according to the determined result. At step 703, the data processing module 101 obtains and processes the data, which are provided for the LCD panel 106 to display the images. Specifically, the data processing module 101 obtains and processes image data of the images, and then dispatches the processed image data to the data driving module 104. At step 704, the scan driving module 105 increases or decreases an output frequency of a scan signal according to the controlling signal of the control module 103. At step 705, the data driving module 104 increases or decreases an output frequency of a data signal according to the controlling signal of the control module 103. At step 706, the LCD panel 106 displays the images.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A liquid crystal display (LCD) system comprising an LCD device, the LCD device comprising: an LCD panel, a data driving module, a scan driving module, and a control module, the control module electrically coupled to the data driving module and the scan driving module, both the data driving module and the scan driving module electrically coupled to the LCD panel, the LCD device further comprising:
a display mode setting module, utilized to set display modes of the LCD device, the display mode comprising at least a multi-3D-image display mode, the display mode setting module electrically coupled to the control module, the control module utilized to control the scan driving module and the data driving module according to the display modes;
a data processing module, the control module electrically coupled to the data processing module, the data processing module electrically coupled to the data driving module, the control module further utilized to control the data processing module according to the display modes, the data processing module utilized to obtain one or more sets of image data according to a controlling signal of the control module and to process the one or more sets of the image data, and utilized to provide the processed image data for the data driving module;
the scan driving module further utilized to increase or decrease an output frequency of a scan signal according to the controlling signal of the control module;
the data driving module further utilized to increase or decrease an output frequency of a data signal according to the controlling signal of the control module.

2. The LCD system according to claim 1, wherein the LCD system further comprises glasses utilized to view images displayed by the LCD device, the glasses further utilized to be passed by the images displayed by the LCD device according to the display mode set by the display mode setting module.

3. The LCD system according to claim 2, wherein in the multi-3D-image display mode, the LCD panel outputs a left-eye image/a right-eye image of one or more sets of images in sequence, and then outputs a right-eye image/a left-eye image of the one or more sets of images in sequence.

4. The LCD system according to claim 2, wherein in the multi-3D-image display mode, the LCD panel is utilized to output a left-eye image and a right-eye image of a first set of images on a first polarized direction in sequence, and to simultaneously output a left-eye image and a right-eye image of a second set of images on a second polarized direction differed from the first polarized direction in sequence.

5. The LCD system according to claim 2, wherein in the multi-3D-image display mode, the LCD panel is utilized to firstly output a left-eye image and a right-eye image of a first set of images simultaneously on a first polarized direction and a second polarized direction differed from the first polarized direction, and then to simultaneously output a left-eye image and a right-eye image of a second set of images on the first polarized direction and the second polarized direction.

6. An LCD system comprising an LCD device, the LCD device comprising an LCD panel, a data driving module, a scan driving module, and a control module, the control module electrically coupled to the data driving module and the scan driving module, both the data driving module and the scan driving module electrically coupled to the LCD panel, wherein the LCD device further comprises:
a display mode setting module, utilized to set display modes of the LCD device, the display mode comprising at least a multi-3D-image display mode, the display mode setting module electrically coupled to the control module;
the control module utilized to control the scan driving module and the data driving module according to the display modes.

7. The LCD system according to claim 6, wherein the LCD device further comprises a data processing module, the control module electrically coupled to the data processing module, the data processing module electrically coupled to the data driving module, the control module further utilized to control the data processing module according to the display modes;
the data processing module utilized to obtain one or more sets of image data according to a controlling signal of the control module and to process the one or more sets of the image data, and utilized to provide the processed image data for the data driving module.

8. The LCD system according to claim 6, wherein the scan driving module is further utilized to increase or decrease an output frequency of a scan signal according to the controlling signal of the control module; and/or the data driving module is further utilized to increase or decrease an output frequency of a data signal according to the controlling signal of the control module.

9. The LCD system according to claim 6, wherein the LCD system further comprises glasses utilized to view images displayed by the LCD device, the glasses further utilized to be passed by the images displayed by the LCD device according to the display mode set by the display mode setting module.

10. The LCD system according to claim 6, wherein in the multi-3D-image display mode,
the LCD panel firstly outputs a left-eye image/a right-eye image of one or more sets of images in sequence, and then outputs a right-eye image/a left-eye image of the one or more sets of images in sequence; or
the LCD panel outputs a left-eye image and a right-eye image of a first set of images on a first polarized direction in sequence, and simultaneously outputs a left-eye image and a right-eye image of a second set of images on a second polarized direction differed from the first polarized direction in sequence; or
the LCD panel firstly outputs a left-eye image and a right-eye image of the first set of images simultaneously on a first polarized direction and a second polarized direction differed from the first polarized direction, and then simultaneously outputs a left-eye image and a right-eye image of the second set of images on the first polarized direction and the second polarized direction.

11. A method for displaying images in an LCD system, the LCD system comprising an LCD device, the LCD device comprising an LCD panel, a data driving module, a scan driving module, and a control module, the control module electrically coupled to the data driving module and the scan driving module, both the data driving module and the scan driving module electrically coupled to the LCD panel, wherein the LCD device further comprises a display mode setting module, the display mode setting module electrically coupled to the control module, the method comprising the following steps of:
(A) setting display modes of the LCD device by the display mode setting module, the display mode comprising at least a multi-3D-image display mode;
(B) controlling the scan driving module and the data driving module by the control module according to the display modes.

12. The method according to claim 11, wherein the LCD device further comprises a data processing module, the control module electrically coupled to the data processing module, the control module further utilized to control the data processing module according to the display modes, the method further comprising the following step of:
(C) obtaining one or more sets of image data by the data processing module according to a controlling signal of the control module and to process the one or more sets of the image data, and providing the processed image data for the data driving module.

13. The method according to claim 11, wherein the method further comprises the following steps of:
(D) increasing or decreasing an output frequency of a scan signal by the scan driving module according to the controlling signal of the control module; and/or
(E) increasing or decreasing an output frequency of a data signal by the data driving module according to the controlling signal of the control module.

14. The method according to claim 11, wherein the LCD system further comprising glasses utilized to view images displayed by the LCD device, the method further comprising the following step of:
(F) passing through the glasses by the images displayed by the LCD device according to the display mode set by the display mode setting module.

15. The method according to claim 11, wherein in the multi-3D-image display mode, the method further comprising the following step of:
(G) firstly outputting a left-eye image/a right-eye image of one or more sets of images in sequence, and then outputting a right-eye image/a left-eye image of the one or more sets of images in sequence by the LCD panel; or
(H) outputting a left-eye image and a right-eye image of a first set of images on a first polarized direction in sequence by the LCD panel, and simultaneously outputting a left-eye image and a right-eye image of a second set of images on a second polarized direction differed from the first polarized direction in sequence; or
(I) firstly outputting a left-eye image and a right-eye image of a first set of images simultaneously on a first polarized direction and a second polarized direction differed from the first polarized direction by the LCD panel, and then simultaneously outputting a left-eye image and a right-eye image of the second set of images on the first polarized direction and the second polarized direction.
